(19) United States
(12) Patent Application Publication
(10) Pub. No.: US 2025/0165187 A1
(43) Pub. Date: May 22, 2025

(54) APPARATUS AND METHOD FOR SCHEDULING AND ARBITRATION QOS IMPROVEMENT BY EARLY FEEDBACK

(71) Applicant: SAMSUNG ELECTRONICS CO., LTD., Suwon-si (KR)

(72) Inventors: Vipin Kumar AGRAWAL, San Jose, CA (US); Vasili ZHDANKIN, Prior Lake, MN (US); Jaegeun PARK, Suwon-si (KR); Daniel Lee HELMICK, Thornton, CO (US)

(73) Assignee: SAMSUNG ELECTRONICS CO., LTD., Suwon-si (KR)

(21) Appl. No.: 18/793,347

(22) Filed: Aug. 2, 2024

Related U.S. Application Data
(60) Provisional application No. 63/600,314, filed on Nov. 17, 2023.

(51) Int. Cl. G06F 3/06

(52) U.S. Cl. CPC G06F 3/0659; G06F 3/0604; G06F 3/0679

(57) ABSTRACT

A device includes: one or more internal queues; and processing circuitry configured to: fetch data from one or more submission queues of a host device, receive first feedback information from the one or more internal queues, control transfer of the data from the one or more submission queues to the one or more internal queues based on the first feedback information, receive second feedback information from a memory device coupled to the processing circuitry, and control the transfer of the data from the one or more internal queues to the memory device based on the second feedback information.

### CROSS-REFERENCE TO RELATED APPLICATION

This application claims priority to U.S. provisional application No. 63/600,314 filed on Nov. 17, 2023, the entire contents of which are incorporated herein by reference.

### BACKGROUND

### 1. Field

This disclosure is directed to scheduling and arbitration Quality of Service (QoS) improvement by early feedback.

### 2. Related Art

In a scheduler such as a network scheduler, an arbitration mechanism fetches a command from a host device and parses the command. The command may consume resources in a pipeline, and may be stored in one or more internal queues. The command may be scheduled to a NAND storage device. A rate limiter may be used to limit a performance for a tenant of the host device by delaying submission to a completion queue. However, there is no direct feedback between resource bottlenecks, which may cause backups resulting in high performance variance. Furthermore, feedback in later stages in the processing pipeline may make a system slow to respond to changing workloads and associated resource bottlenecks.

### SUMMARY

According to one or more embodiments, a device includes: one or more internal queues; and processing circuitry configured to: fetch data from one or more submission queues of a host device, receive first feedback information from the one or more internal queues, control transfer of the data from the one or more submission queues to the one or more internal queues based on the first feedback information, receive second feedback information from a memory device coupled to the processing circuitry, and control the transfer of the data from the one or more internal queues to the memory device based on the second feedback information.

According to one or more embodiments, a method performed by at least one processor includes fetching data from one or more submission queues of a host device; receiving first feedback information from one or more internal queues; controlling transfer of the data from the one or more submission queues to the one or more internal queues based on the first feedback information, receiving second feedback information from a memory device coupled to the processor, and controlling the transfer of the data from the one or more internal queues to the memory device based on the second feedback information.

According to one or more embodiments, a non-transitory computer readable medium having instructions stored therein, which when executed by a processor cause the processor to perform a method including: fetching data from one or more submission queues of a host device; receiving first feedback information from one or more internal queues; controlling transfer of the data from the one or more submission queues to the one or more internal queues based on the first feedback information; receiving second feedback information from a memory device coupled to the processor; and controlling the transfer of the data from the one or more internal queues to the memory device based on the second feedback information.

### BRIEF DESCRIPTION OF DRAWINGS

Further features, the nature, and various advantages of the disclosed subject matter will be more apparent from the following detailed description and the accompanying drawings in which:

FIG. 1 is a schematic illustration of a scheduler system, in accordance with embodiments of the present disclosure.

FIG. 2 is a schematic illustration of a scheduler system that implements intermediate feedback between resource bottlenecks, in accordance with embodiments of the present disclosure.

FIG. 3 is a schematic illustration of a scheduler system that implements a scheduler at a central decision making point which implements deficit weighted round robin (DWRR) to support weighted fair queuing (WFQ), in accordance with embodiments of the present disclosure.

FIG. 4 is a schematic illustration of a scheduler system that implements credit based feedback if multiple paths are involved, in accordance with embodiments of the present disclosure.

FIG. 5 is a schematic illustration of a scheduler system that delays an SQ head pointer update, in accordance with embodiments of the present disclosure.

FIG. 6A illustrates an example table for WFQ, in accordance with embodiments of the present disclosure.

FIG. 6B illustrates an example table for DWRR, in accordance with embodiments of the present disclosure.

FIG. 6C illustrates an example table for DWRR WFQ, in accordance with embodiments of the present disclosure.

FIG. 6D illustrates an example table for a rate limiter, in accordance with embodiments of the present disclosure.

FIG. 7 is flow chart of an example process for controlling transfer of data in a scheduler system based on early feedback, in accordance with embodiments of the present disclosure.

FIG. 8 is a block diagram of an example processor, in accordance with embodiments of the present disclosure.

### DETAILED DESCRIPTION

The following detailed description of example embodiments refers to the accompanying drawings. The same reference numbers in different drawings may identify the same or similar elements. In the drawings, reference numerals beginning with “S” refer to operations of a process or method.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware or firmware. The actual specialized control hardware used to implement these systems and/or methods is not limiting of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

Embodiments of the present disclosure are directed to a system, apparatus, and method for improving bandwidth (BW) and input/output operations per second (IOPS) for multiple tenants by providing downstream resource usage feedback to the scheduler. The embodiments of the present disclosure improve multi tenancy performance for IOPS/BW specification, QoS, and reduced variance.

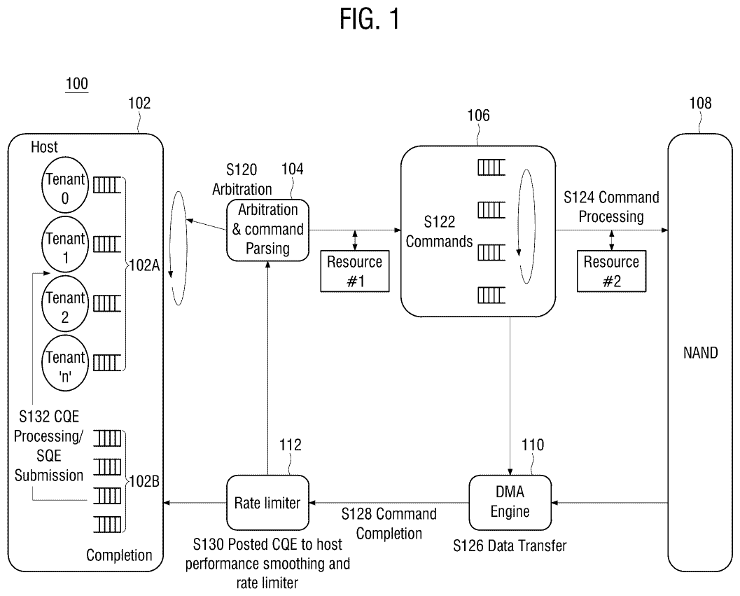

FIG. 1 illustrates an example scheduler system 100 that includes a host 102. The operations of the scheduler system 100 are described with respect to operations of a method (e.g., S120, etc.). The host 102 may be any device or group of devices that provide networking or cloud services to one or more tenants. For example, the host 102 may provide cloud computing services to tenants Tenant 0, Tenant 1, Tenant 2, . . . . Tenant n. In one or more examples, the host 102 may be a system or one or more servers that includes one or more processors and, and further includes one or more memory devices that correspond to one or more submission queues 102A and one or more completion queues 102B. The tenants may submit one or more commands to a corresponding submission queue. For example, each tenant may be associated with a separate set of one or more submission queues 102A, where the tenant submits data or commands to the one or more submission queues for processing. Accordingly, while the data or commands are in the submission queues, the data or commands are waiting to be processed. An amount of time that the data or command waits in the submission queues may correspond to a QoS provided to a particular tenant. In one or more examples, a tenant may subscribe to a cloud computing service provided by the host 102, where based on a subscription level, the tenant may be guaranteed a specific QoS. For example, tenants that pay a higher subscription fee may be guaranteed a higher level QoS than tenants paying a lower subscription fee.

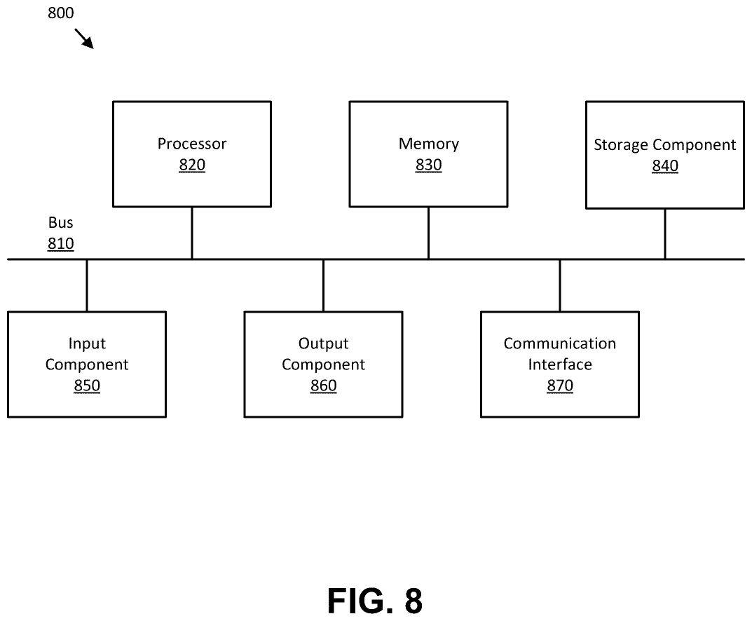

The output of a command from the submission queue may be determined by an arbitration and command parsing function 104 performing an arbitration operation (S120) that determines a rate at which data or commands are retrieved from the submission queues for each tenant. For example, the arbitration and command parsing function 104 may fetch or retrieve commands from the one or more submission queues according to a set of rules or conditions. For example, the set of rules or conditions may be determined based on a QoS guaranteed to a particular tenant. The arbitration and command parsing function 104 may parse the command into a smaller set of commands or functions for processing. For example, the arbitration and command parsing function 104 may parse a command into a subset of commands. The arbitration and command parsing function 104 may be implemented by processing circuitry. Examples of processing circuitry are disclosed in FIG. 8.

The fetched or retrieved command may consume resources (e.g., Resource #1) in the pipeline. For example, when a command is fetched from a submission queue, the processing of the command (S122) may consume available processing capacity. For example, once a command is fetched from a submission queue, one or more computations may need to be performed that consumes resources of the processing circuitry. The scheduler system 100 may further include one or more internal queues 106 used to store the commands. The one or more internal queues 106 may be implemented by memory circuitry. The memory circuitry may be part of the same device including the processing circuitry that implements the arbitration and command parsing function 104.

The scheduler system 100 may include a backend memory device such as a NAND 108. The command in the one or more internal queues 106 may be output for command processing and stored the NAND 108. As understood by one of ordinary skill in the art the NAND 108 may be a flash memory. The NAND 108 flash memory may be a non-volatile storage technology that does not require power to retain data.

During command processing, a second set of resources (e.g., Resource #2) may be consumed during command processing (S124). For example, when a command is fetched from one of the one or more internal queues 106, the fetched command may require the storing or retrieval of data from the NAND 108, which may consume resources such as memory bandwidth (e.g., the rate at which data may be stored or retrieved from a memory).

After the data is transferred between the host memory (e.g., one or more submission queues 102A) and the NAND storage (or the device memory), the command is completed. The command or data may be transferred from the NAND 108 to a direct memory access (DMA) engine 110 (S126). In one or more examples, the DMA engine 110 is configured to access the NAND 108 independently of processing circuitry such as processing circuitry that implements one or more rate control operations. The DMA engine 110 may be used when the CPU is unable to keep up with a rate of data transfer, or when the CPU needs to perform work while waiting for slow I/O data transfer. In one or more examples, the DMA engine 110 may perform memory to memory copying or moving of data within memory. The DMA engine 110 may advantageously offload time consuming and high bandwidth memory operations from the CPU such as large copies or data transfers.

The scheduler system 100 may include a rate limiter 112 that is used to limit the performance for a tenant by delaying the submission to the one or more completion queues 102B. For example, without the rate limiter 112, upon completion of a command (S128), the completed command may return to the host 102 for completion queue or submission queue processing (S132). In one or more examples, the rate limiter 112 may delay a command to a submission queue. The delaying the posting of the new command to the submission queue may result in improving a QoS for one or more tenants. The rate limiter 112 may further control the arbitration command and parsing function 104 to control a rate at which commands are fetched from the one or more submission queues.

In the scheduler system 100, there is no direct feedback between resource bottlenecks, which may cause temporary backups resulting in high performance variance. Schedulers that are deeply embedded in the pipeline (e.g., pipeline for processing a command) have more visibility in the resource usage, but are limited by the availability of the commands in the queues of the schedulers (e.g., one or more internal queues 106).

Feedback at later stages (e.g., rate limiter 112 posting a command to a completion queue or submission queue (S132)) results in the scheduler system 100 being slow to respond to changing workloads and associated resource bottlenecks. When there is a very large queue depth, completion queue processing and submission queue submission are not very effective, or have very high variance, resulting in performance degradation for one or more tenants. In the scheduler system 100, in one or more examples, the two scheduling decision points may be the arbitration and command parsing function 104 and the rate limiter 112, that may implement weighted fair queuing (WFQ). However, in the scheduler system 100, only the rate limiter 112 provides feedback, which occurs at the end of the processing pipeline.

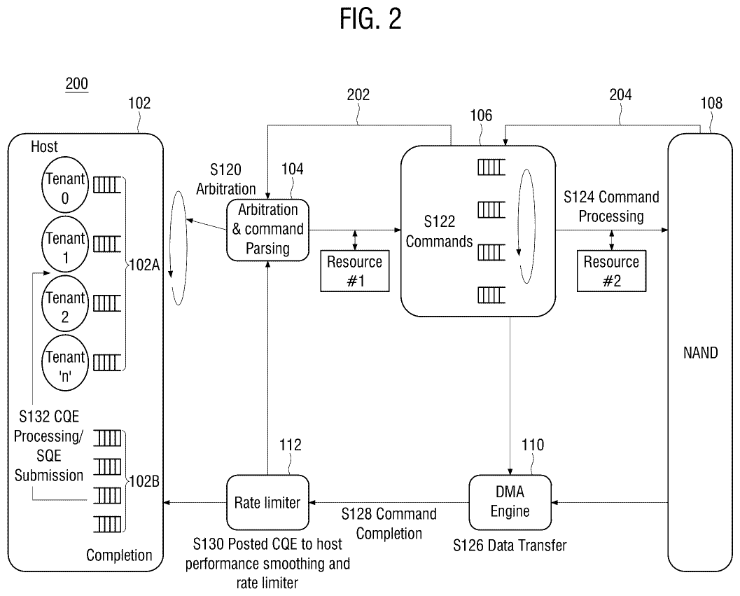

FIG. 2 illustrates an example of a scheduler system 200 that implements intermediate feedback between resource bottlenecks, in accordance with embodiments of the present disclosure. For example, as illustrated in FIG. 2, the arbitration and command parsing function 104 may receive first feedback 202 from the one or more internal queues 106. The first feedback 202 may be a credit feedback generated by processing circuitry (e.g., memory controller) of the one or more internal queues 106 that indicates downstream resource usage such as resources (e.g., Resource #1) consumed by commands fetched from the one or more submission queues 102. For example, the first feedback 202 may indicate the amount of resources consumed by each of Tenants 0 . . . . N. Based on the first feedback 202, the arbitration and command parsing function 104 may increase or decrease a rate at which commands are fetched from the one or more submission queues 102A. For example, if the first feedback 202 indicates that an amount of resources consumed is above a threshold, the arbitration and command parsing function 104 may decrease the rate at which commands are fetched from the one or more submission queues 102A. In another example, if the first feedback 202 indicates that an amount of resources consumed is below a threshold, the arbitration and command parsing function 104 may increase the rate at which commands are fetched from the one or more submission queues 102A.

In one or more examples, the arbitration and command parsing function 104 may perform an action for a specific tenant. For example, if the first feedback 202 indicates that an amount of resources consumed by Tenant 0 is above a threshold, the arbitration and command parsing function 104 may decrease a rate at which commands are fetched from one or more submission queues associated with Tenant 0 based on the first feedback 202. In one or more examples, if the first feedback 202 indicates that an amount of resources consumed by Tenant 0 is below a threshold, and a level of QoS Tenant 0 is currently receiving is below a QoS level guaranteed to Tenant 0, the arbitration and command parsing function 104 may increase a rate at which commands are fetched from the one or more submission queues associated with Tenant 0.

In one or more examples, the arbitration and command parsing function 104 may perform an action for two or more tenants. For example, if the first feedback 202 indicates that an amount of resources consumed by Tenant 0 is above a threshold, and an amount of resources consumed by Tenant 1 is below a threshold, the arbitration command and parsing function 104 may simultaneously decrease a rate at which commands are fetched from the one or more submission queues associated with Tenant 0 and increase a rate at which commands are fetched from the one or more submission queues associated with Tenant 1. In one or more examples, an amount the rate is decreased for Tenant 0 may be equal to an amount the rate is increased for Tenant 1. In one or more examples, the amount the rate is decreased for Tenant 0 may be different than the amount the rate is increased for Tenant 1.

In one or more examples, the arbitration and command parsing function 104 may perform a same action for each of the tenants. For example, based on an amount of resources consumed by all the tenants, the arbitration and command parsing function 104 may increase or decrease the rate at which commands are fetched for each tenant. For example, if the first feedback 202 indicates that a total amount of resources consumed by the tenants is above a threshold, the arbitration and command parsing function 104 may decrease a rate at which commands are fetched from the one or more submission queues for each tenant. An amount that the rate is decreased for each tenant may be different or the same. In one or more examples, if the first feedback 202 indicates that the total amount of resources consumed by the tenants is below a threshold, the arbitration and command parsing function 104 may increase the rate at which commands are fetched from the one or more submission queues for each tenant. An amount that the rate is increased for each tenant may be different or the same.

In one or more examples, the scheduler system 200 may include second feedback 204 provided by a NAND management component that monitors data transfers between the one or more internal queues 106 and the NAND 108 to the one or more submission queues 106. In one or more examples, the NAND management component may be a processor such as a processor 802, which is described in further detail below with respect to FIG. 8. The second feedback 204 may indicate an amount of resources (e.g., Resource #2) consumed by commands fetched from the one or more internal queues 106. Based on the second feedback 204, a rate at which commands are transferred from the one or more internal queues 106 to the NAND 108 may increase or decrease. For example, if the second feedback 204 indicates that an amount of resources consumed is above a threshold, the rate at which commands are fetched from the one or more internal queues 106 may decrease. In another example, if the second feedback 204 indicates that an amount of resources consumed is below a threshold, the rate at which commands are fetched from the one or more internal queues 106 may increase. In one or more examples, the second feedback information 204 may include multiple feedback loops. For example, the NAND management component may include one or more processors that perform NAND management, command aggregation, advanced NAND scheduling, etc. Accordingly, the second feedback information 204 may provide information related to a feedback loop for NAND management, a feedback loop for command aggregation, a feedback loop for advanced NAND scheduling, etc.

In one or more examples, the rate at which commands are fetched from the one or more internal queues 106 may be adjusted for a specific tenant. For example, if the second feedback 204 indicates that an amount of resources (e.g., Resource #2) consumed by Tenant 0 is above a threshold, a rate at which commands are fetched from one or more internal queues 106 associated with Tenant 0 may decrease. In one or more examples, if the second feedback 204 indicates that an amount of resources consumed by Tenant 0 is below a threshold, and a QoS Tenant 0 is currently receiving is below a QoS level guaranteed to Tenant 0, the rate at which commands are fetched from the one or more internal queues 106 associated with Tenant 0 may increase.

In one or more examples, the rate at which commands are fetched from the one or more internal queues 106 may be adjusted based on the second feedback 204 for two or more tenants. For example, if the second feedback 204 indicates that an amount of resources consumed by Tenant 0 is above a threshold, and an amount of resources consumed by Tenant 1 is below a threshold, a rate at which commands are fetched from the one or more internal queues associated with Tenant 0 may be decreased and a rate at which commands are fetched from the one or more internal queues 106 associated with Tenant 1 may be increased. In one or more examples, an amount the rate is decreased for Tenant 0 may be equal to an amount the rate is increased for Tenant 1. In one or more examples, the amount the rate is decreased for Tenant 0 may be different than the amount the rate is increased for Tenant 1.

In one or more examples, the rate at which commands are fetched from the one or more internal queues 106 may be adjusted for each of the tenants. For example, based on an amount of resources consumed by all the tenants, rate at which commands are fetched from the one or more internal queues 106 may increase or decrease for each tenant. For example, if the second feedback 204 indicates that a total amount of resources (e.g., Resources #2) consumed by the tenants is above a threshold, the rate at which commands are fetched from the one or more internal queues 106 may decrease for each tenant. An amount that the rate is decreased for each tenant may be different or the same. In one or more examples, if the second feedback 204 indicates that the total amount of resources (e.g., Resource #2) consumed by the tenants is below a threshold, the rate at which commands are fetched from the one or more internal queues 106 may increase for each tenant. An amount that the rate is increased for each tenant may be different or the same.

In one or more examples, the first feedback 202 may be influenced by the second feedback 204. For example, based on the second feedback 204, the rate at which commands are fetched from the one or more internal queues 106 may increase, thereby resulting in a higher amount of memory being available, which influences the rate at which commands are fetched from the submission queue 102A by the arbitration and command parsing function 104. In another example, based on the second feedback 204, the rate at which commands are fetched from the one or more internal queues may decrease, thereby resulting in a lower amount of memory being available, which influences the rate at which commands are fetched from the submission queue 102A by the arbitration and command parsing function 104.

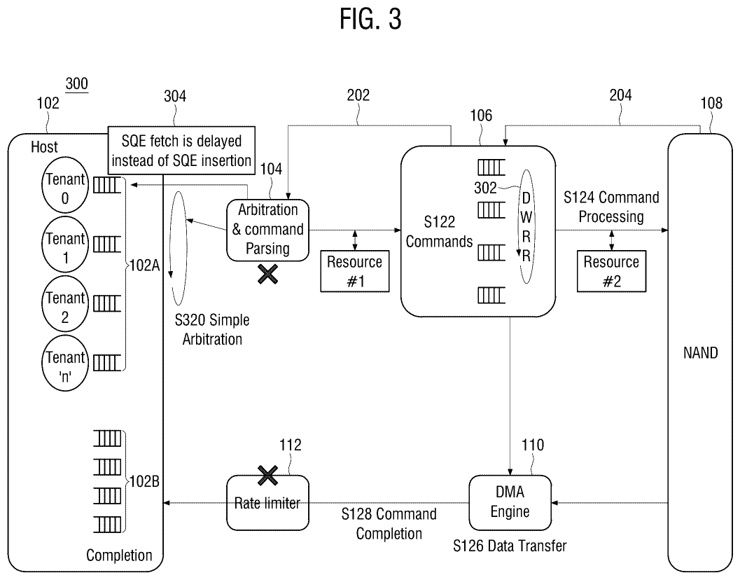

FIG. 3 illustrates an example scheduler system 300 that implements a scheduler at a central decision making point which implements deficit weighted round robin (DWRR) to support WFQ, in accordance with embodiments of the present disclosure. The scheduler system 300 is described with respect operations of a method (e.g., S320, etc.). As illustrated in FIG. 3, DWRR 302 may be implemented at the one or more internal queues 106. The DWRR 302 may adjust the rate at which commands from the one or more internal queues 106 are fetched based on the second feedback 204. As understood by one of ordinary skill in the art, the DWRR operation may be performed by scanning all non-empty internal queues in sequence. Each queue to which DWRR is applied may be associated with a deficit counter and a quantum value indicating a maximum number of bytes that may be fetched from a respective queue. When a non-empty internal command queue i is selected, the deficit counter for this queue is incremented by the quantum value. Subsequently, the value of the deficit counter may be a maximal number of bytes that can be sent at this turn: if the deficit counter is greater than a command's size at the head of a queue, this command may be sent, and the value of the counter is decremented by the command size. Subsequently, the size of the next command is compared to the counter value. Once the queue is empty or the value of the counter is insufficient, the next queue will be checked. If the queue is empty, the value of the deficit counter is reset to 0. In the scheduler system 300, the DWRR 302 may act as a rate limiter. Accordingly, in one or more examples, the rate limiter 112 may be eliminated.

In one or more example examples, the arbitration and command parsing function may retrieve commands from the one or more submission queues based on an arbitration procedure S320. In one or more examples, the arbitration procedure S320 may be WFQ. Furthermore, as illustrated in FIG. 3, the fetching of commands from the one or more submission queues 102A may be delayed (304) instead of insertion of commands into the one or more submission queues 102A.

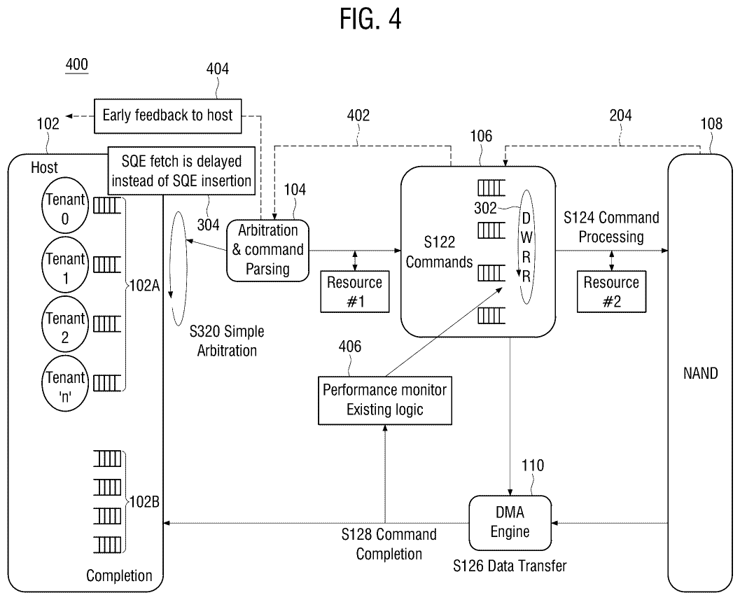

FIG. 4 illustrates an example scheduler system 400 that implements credit based feedback, in accordance with embodiment of the present disclosure. In one or more examples, credit based feedback may be implemented if multiple paths are involved. As illustrated in FIG. 4, feedback 404 is provided from the one or more internal queues 106 to the arbitration and command parsing 404. The feedback 404 may provide information to slow down or speed up the rate at which commands are fetched from the one or more submission queues 102A. For example, the feedback 404 may include a parameter that indicates an amount that the rate at which commands are fetched from the one or more submission queues 102A is decreased or increased. Accordingly, compared to first feedback 202, the feedback 402 does not include information indicating an amount of resource usage such as exact credits. In one or more examples, the feedback 402 may specify a rate change for one or more tenants. For example, the feedback 402 may specify that the rate for fetching commands from the one or more submission queues associated with Tenant 0 is increased, while the rate for fetching commands from the one or more submission queues associated with Tenant 1 is decreased. In one or more examples, the feedback 402 may be specified by an array where each index in the array is associated with a particular tenant. For example, the feedback 402 may be specified as: [1 −1 0 0]. In this example, the feedback 402 may indicate that the rate for Tenant 0 is increased by a unit of 1, the rate for Tenant 1 is decreased by a unit of 1, and the rates for Tenants 2 and 3 remain the same. In one or more examples, the unit for increasing or decreasing may correspond to any suitable rates known to one or ordinary skill in the art such as Gb/s, Mb/s, Kb/s, etc.

As illustrated in FIG. 4, early feedback 404 may be provided from arbitration and command parsing function 104 to the host 102. Based on the early feedback 404, the host may control a rate at which commands are inserted into the one or more submission queues 102A. For example, the feedback 404 may indicate that the rate at which commands are inserted into the one or more submission queues 102A may be increased. In another example, the feedback 404 may indicate that the rate at which commands are inserted into the one or more submission queues 102A may be decreased.

As illustrated in FIG. 4, the one or more internal queues 106 may receive information from a performance monitor 406, which may be used by the DWRR 202 function to adjust a rate at which commands are fetched from the one or more internal queues 106. In one or more examples, the performance monitor 406 may provide information corresponding to the performance of one or more tenants over a period of time. For example, with respect to Tenant 0, feedback 204 may indicate an amount of resource usage for a specific resource (e.g., Resource #2) for one or more commands associated with Tenant 0. In contrast, the performance monitor 406 may provide information regarding a total number of resources used by Tenant 0 (e.g., Resource #1 and Resource #2) for a series of commands that contains a larger number of commands than the one or more commands reflected in feedback 204. The performance monitor 406 may generate feedback information after one or more commands are completed.

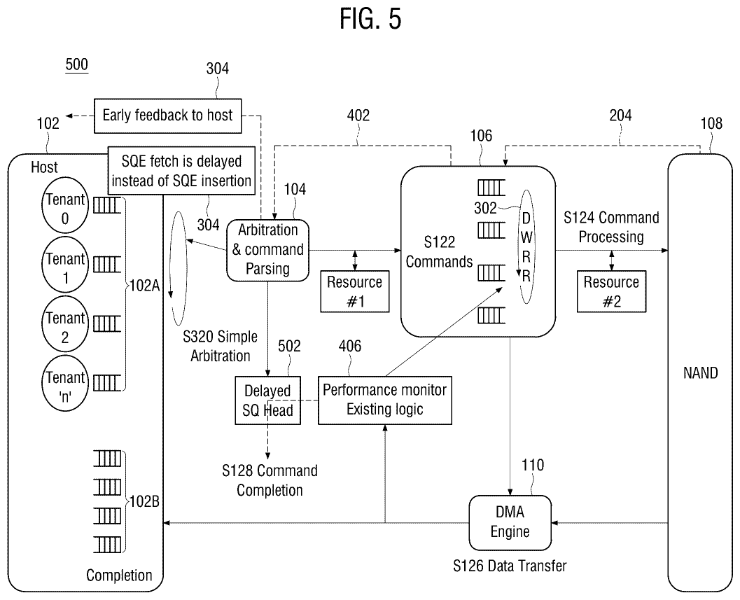

FIG. 5 illustrates a scheduler system 500 that delays a submission queue (SQ) head pointer update for further refinement of the rate at which commands are inserted into a submission queue 102A, in accordance with embodiments of the present disclosure. For example, as illustrated in FIG. 5, a delayed SQ head function 502 receives information from the performance monitor 406. In one or more examples, each of the one or more submission queues includes a head pointer (e.g., SQ head pointer) and a tail pointer (e.g., SQ tail pointer). The distance between the head pointer and the tail pointer may represent the number of commands in a respective submission queue. When a command is fetched from a submission queue, a position of the head pointer may be updated to reflect that a number of commands in the submission queue has decreased. When a command is inserted into the submission queue, a position of the tail pointer may be updated to reflect that the number of commands in the submission queue has increased. When the distance between the tail pointer and the head pointer is a maximum size (e.g., the submission queue has a maximum number of allowed commands), insertion of new commands into the submission queue may be delayed or prevented.

In one or more examples, the delayed SQ head function 502 may receive information from the performance monitor 406. The information from the performance monitor 406 may include performance information (e.g., an amount of resource consumed) for each tenant in the host 102. Based on the information from the performance monitor 406, the SQ head function 502 may delay an update of an SQ head point of a submission queue of a respective tenant, thereby resulting in a delay of an insertion of a command in the queue. For example, if the performance monitor 406 indicates that an amount of resources consumed by a Tenant 0 is above a threshold, an update of the position of the head pointer for a submission queue associated with the Tenant 0 is delayed when a command is fetched from the submission queue, thereby delaying an insertion of a new command into the submission queue. The SQ head may be updated based on information from the performance monitor 406 for command completion.

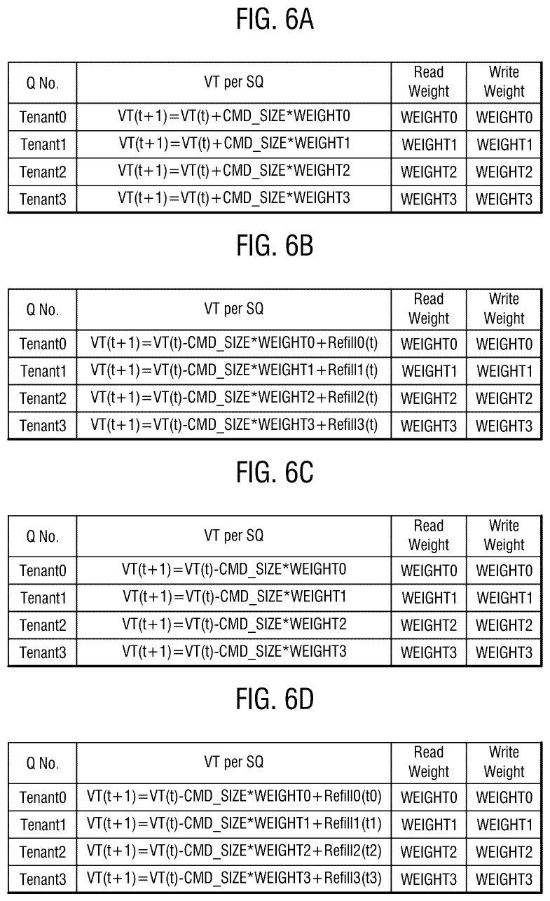

FIGS. 6A-6D illustrate an example implementation of implementing the queuing algorithms (e.g., WFQ, DWRR) for any of the queues associated with the tenants (e.g., Tenant 0-Tenant N) discussed above with respect to the scheduler systems described in FIGS. 1-5. In one or more examples, the queueing algorithms may be implemented based on a virtual token (VT). In one or more examples, the VT may be an integer number. For example, a VT with a value of three (3) represents three (3) tokens. When a tenant has one or more tokens available, commands included in a queue (e.g., submission queue) associated with the tenant may be fetched. The implementation of the queuing algorithms may further be based on a command size (CMD_SIZE), a weight (e.g., WEIGHT0-WEIGHT3), and a refill parameter (e.g., Refill0-Refill3). In one or more examples, the command size may represent the size of a command inserted or fetched from a queue. In one or more examples, each tenant may be associated with a respective weight (e.g., WEIGHT0-WEIGHT3) that may be correlated with a tenant's priority. For example, a first tenant with a higher priority than a second tenant may be associated with a weight such that the VT for the first tenant remains higher or is decremented at a lower rate than the second tenant. The weights may be designated as a read weight and a write weight. For example, the read weight may be used when a command is fetched from a queue, and a write weight may be used when a command is inserted into a queue. In one or more examples, the refill parameter may be added to a VT to increase the value of the VT. In one or more examples, the refill parameter may be added to the VT at a predetermined time.

FIGS. 6A-6D illustrate various processes for updating the VT. FIG. 6A illustrates an example table for WFQ, in accordance with embodiments of the present disclosure. The WFQ algorithm may search a minimum VT from all active queues. The WFQ algorithm may update the VT based on the command size and the associated weight value for a respective tenant (e.g., WEIGHT0-WEIGHT3). The WFQ algorithm may limit a max difference between VTs.

FIG. 6B illustrates an example table for DWRR, in accordance with embodiments of the present disclosure. The DWRR algorithm may perform round robin across all the eligible tenants. As illustrated in FIG. 6B, a respective VT for each tenant may be updated based on a command size, a respective weight for each tenant (e.g., WEIGHT0-WEIGHT3), and the respective refill parameter for each tenant (e.g., Refill0-Refill3). The DWRR may select all the tenants with CMD_SIZE′n′*weight′n′<VT′n′. As understood by one of ordinary skill in the art, the DWRR provides implementation flexibility. If the CMD_SIZE′n′ is not known, the VT may be allowed to go to a negative value. The DWRR algorithm may be configured to behave like a rate limiter. For example, instead of round robin, the DWRR algorithm may implement fixed slots. Furthermore, the DWRR algorithm may be overprovisioned to account for backend jitter.

FIG. 6C illustrates an example table for DWRR (WFQ), in accordance with embodiments of the present disclosure. Compared to the algorithm illustrated in FIG. 6A, the algorithm in FIG. 6C updates a respective token for each tenant by subtracting the command size from the respective token. The DWRR (WFQ) algorithm may implement round robin across all the eligible tenants. The DWRR (WFQ) algorithm may select all the eligible tenants with VT′n′>0 and a non-empty queue. The DWRR (WFQ) algorithm may update the VT by subtracting by CMD_Size*weight′n′. If no tenant is selected, the DWRR (WFQ) algorithm may update the VTs. The DWRR (WFQ) algorithm may use one of the following two options: (1) reset all VTs to same configured value; or (2) add a configured value to VTs, and saturate VTs to max configured value. In option (2), an idle tenant may get extra access, but may be more complex to implement.

FIG. 6D illustrates an example table for a rate limiter, in accordance with embodiments of the present disclosure. Compared to the algorithm illustrated in FIG. 6B, as illustrated in FIG. 6D, the respective refill parameter (e.g., Refill0-Refill3) is added to a VT of a respective tenant at a respective time (e.g., t0-t3). The rate limiter may implement round robin across all the eligible tenants. The rate limiter may select all the tenants with VT′n′>0 and a non-empty queue. The rate limiter may update the VT by subtracting by CMD_Size*weight′n′. The rate limiter may use one or more of the following reload options: (1) a configured value based on a timer; (2) per tenant configured value based on a timer; (3) per tenant configured value with saturation value based on a timer.

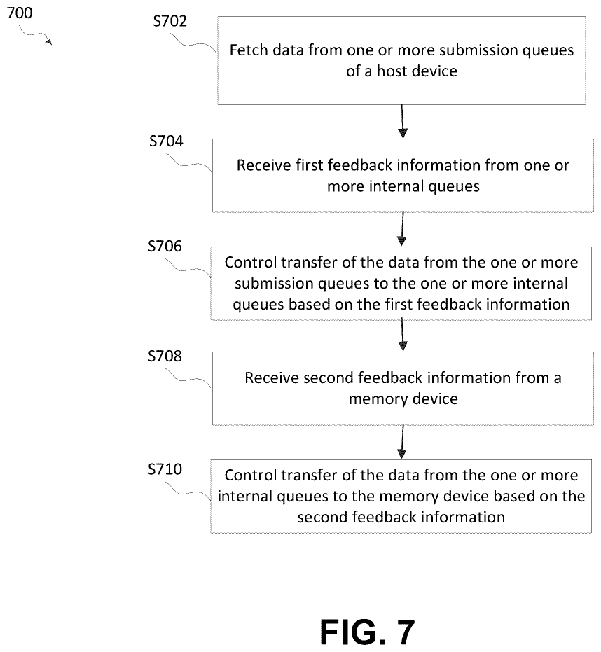

FIG. 7 illustrates a flowchart of an example process 700 for controlling transfer of data in a scheduler system based on early feedback. In one or more examples, the process 700 may start at operation S702 where data is fetched from one or more submission queues of a host device. For example, processing circuitry implementing the arbitration and command parsing function 104 may retrieve one or more commands from one or more submission queues of the host 102.

The process proceeds to operation S704 where first feedback information from one or more internal queues is received. For example, the processing circuitry implementing the arbitration and command parsing function 104 may receive first feedback information 202 (FIG. 2) or first feedback information 402 (FIG. 4) from the one or more internal queues 106 and adjust the rate that commands are fetched from the one or more submission queues from the host 102 accordingly.

The process proceeds to operation S706 where the transfer of data from the one or more submission queues to the one or more internal queues is controlled based on the first feedback information. For example, based on the first feedback information, which may indicate an amount of resources consumed, the processing circuitry implementing the arbitration and command parsing function 104 may speed up or slow down a rate at which commands fetched from the one or more submission queues.

The process proceeds to operation S708 where the second feedback information is received from a memory device. For example, the processing circuitry may receive second feedback information 204 from the NAND 108, where the second feedback information may indicate an amount of resources (e.g., memory bandwidth) consumed by commands fetched from the one or more internal queues.

The process proceeds to operation S710 where transfer of data from the one or more internal queues to the memory device is controlled based on the second feedback information. For example, based on the second feedback information 202, the processing circuitry may increase or decrease a rate at which commands are fetched from the one or more internal queues 106 and forwarded to the NAND 108.

FIG. 8 is a block diagram of example components of one or more devices that implement the embodiments of the present disclosure. As shown in FIG. 8, the device 800 may include a bus 810, a processor 820, a memory 830, a storage component 840, an input component 850, an output component 860, and a communication interface 870.

The bus 810 includes a component that permits communication among the components of the device 800. The processor 820 is implemented in hardware, firmware, or a combination of hardware and software. In one or more examples, the processor 820 may include processing circuitry for implementing the embodiments illustrated in FIGS. 2-6 and the process 700 illustrated in FIG. 7. Although FIG. 8 illustrates one processor 802, as understood by one of ordinary skill in the art, the device 800 may include any number of desired processors.

The processor 820 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 820 includes one or more processors capable of being programmed to perform a function. The memory 830 includes a random access memory (RAM), a read only memory (ROM), and/or another type of dynamic or static storage device (e.g. a flash memory, a magnetic memory, and/or an optical memory) that stores information and/or instructions for use by the processor 820. In one or more examples, the memory 830 may correspond to the one or more internal queues 106.

The storage component 840 stores information and/or software related to the operation and use of the device 800. For example, the storage component 840 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 850 includes a component that permits the device 800 to receive information, such as via user input (e.g. a touch screen display, a keyboard, a keypad, a mouse, a button, a switch, and/or a microphone). Additionally, or alternatively, the input component 850 may include a sensor for sensing information (e.g. a global positioning system (GPS) component, an accelerometer, a gyroscope, and/or an actuator). The output component 860 includes a component that provides output information from the device 800 (e.g. a display, a speaker, and/or one or more light-emitting diodes (LEDs)).

The communication interface 870 includes a transceiver-like component (e.g., a transceiver and/or a separate receiver and transmitter) that enables the device 800 to communicate with other devices, such as via a wired connection, a wireless connection, or a combination of wired and wireless connections. The communication interface 870 may permit the device 800 to receive information from another device and/or provide information to another device. For example, the communication interface 870 may include an Ethernet interface, an optical interface, a coaxial interface, an infrared interface, a radio frequency (RF) interface, a universal serial bus (USB) interface, a Wi-Fi interface, a cellular network interface, or the like.

The device 800 may perform one or more processes described herein. The device 800 may perform these processes in response to the processor 820 executing software instructions stored by a non-transitory computer-readable medium, such as the memory 830 and/or the storage component 840. A computer-readable medium is defined herein as a non-transitory memory device. A memory device includes memory space within a single physical storage device or memory space spread across multiple physical storage devices.

Software instructions may be read into the memory 830 and/or the storage component 840 from another computer-readable medium or from another device via the communication interface 870. When executed, software instructions stored in the memory 830 and/or the storage component 840 may cause the processor 820 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 8 are provided as an example. In practice, the device 800 may include additional components, fewer components, different components, or differently arranged components than those shown in FIG. 8. Additionally, or alternatively, a set of components (e.g. one or more components) of the device 800 may perform one or more functions described as being performed by another set of components of the device 800.

The embodiments have been described above and illustrated in terms of blocks, as shown in the drawings, which carry out the described function or functions. These blocks may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

In one or more examples, each of the arbitration and command parsing function 104, DMA engine 110, rate limiter 112, DWRR 302, performance monitor 406, and delayed SQ head function 502 may be implemented by processing circuitry such as the processor 802. In one or more examples, one or more processors 802 may be utilized for each of these modules. In one or more examples, the processor 802 may retrieve executable instructions from the storage component 840 to perform the functions of these modules described above with respect to FIGS. 1-5. In one or more examples, the internal queues 106 may be implemented by the memory 830, where the processor 802 operating as the DWRR 302 communicates with the memory 830 to fetch data.

In one or more examples, the device 800 may correspond to the host 102, where the processor 802 may retrieve execute instructions from storage component 840 to perform the processing functions of the host 102 such as inserting and retrieving commands from the one or more submission queue 102A. In one or more examples, the one or more submission queues 102A and completion queues 102B may be implemented by the memory 830, where the processor 802 communicates with the memory 830 to fetch data from the one or more submission queues 102A or completion queues 102B or insert data into the one or more submission queues 102A or the completion queues 102B.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:

(1) A device including: one or more internal queues; and processing circuitry configured to: fetch data from one or more submission queues of a host device, receive first feedback information from the one or more internal queues; control transfer of the data from the one or more submission queues to the one or more internal queues based on the first feedback information, receive second feedback information from a memory device coupled to the processing circuitry, and control the transfer of the data from the one or more internal queues to the memory device based on the second feedback information.

(2) The device according to feature (1), in which the first feedback information includes credit information that controls the transfer of data from the one or more submission queues to the one or more internal queues.

(3) The device according to feature (2), in which the credit information includes information indicating an amount of resources used by the data transferred from the one or more submission queues to the one or more internal queues, and in which the processing circuitry is further configured to adjust a rate at which commands are fetched from the one or more submission queues based on the first feedback information.

(4) The device according to any one of features (1)-(3), in which the first feedback information indicates a rate change for changing a transfer rate at which data is transferred from the one or more submission queues to the one or more internal queues.

(5) The device according to feature (4), in which the rate change increases the transfer rate of the data from the one or more submission queues to the one or more internal queues.

(6) The device according to feature (4), in which the rate change decreases the transfer rate of the data from the one or more submission queues to the one or more internal queues.

(7) The device according to any one of features (1)-(6), in which the processing circuitry is further configured to implement a deficit weight round robin scheduling algorithm for the transfer of the data to and from the one or more internal command queues based on the second feedback information.

(8) The device according to feature (7), in which the processing circuitry, based on the deficit weight round robin algorithm, is further configured to control the transfer of data from the one or more internal command queues based on performance monitoring information after completion of a command.

(9) The device according to feature (8), in which the processing circuitry is further configured to delay an update of a head pointer associated with at least one queue from the one or more submission queues based on the first feedback information.

(10) The device according to any one of features (1)-(9), in which the second feedback information includes information indicating an amount of resources used by the data transferred from the one or more internal queues to the memory device.

(11) The device according to feature (10), in which the second feedback information includes information indicating an amount of memory bandwidth used by the data transferred from the one or more internal queues to the memory device and an amount.

(12) The device according to any one of features (1)-(11), in which the data includes one or more commands.

(13) A method performed by at least one processor, the method including: fetching data from one or more submission queues of a host device; receiving first feedback information from one or more internal queues; controlling transfer of the data from the one or more submission queues to the one or more internal queues based on the first feedback information, receiving second feedback information from a memory device coupled to the processor, and controlling the transfer of the data from the one or more internal queues to the memory device based on the second feedback information.

(14) The method according to feature (13), in which the first feedback information includes credit information that controls the transfer of data from the one or more submission queues to the one or more internal queues.

(15) The method according to feature (14), in which the credit information includes information indicating an amount of resources used by the data transferred from the one or more submission queues to the one or more internal queues, and in which the method further includes adjusting a rate at which commands are fetched from the one or more submission queues based on the first feedback information.

(16) The method according to any one of features (13)-(15), in which the first feedback information indicates a rate change for changing a transfer rate at which data is transferred from the one or more submission queues to the one or more internal queues.

(17) The method according to feature (16), in which the rate change increases the transfer rate of the data from the one or more submission queues to the one or more internal queues.

(18) The method according to feature (16), in which the rate change decreases the transfer rate of the data from the one or more submission queues to the one or more internal queues.

(19) The method according to any one of features (13)-(18), in which controlling the transfer of the data from the one or more internal queues to the memory device is further based on a deficit weight round robin scheduling algorithm that controls the transfer of the data to and from the one or more internal command queues to the memory device based on the second feedback information. (20) A non-transitory computer readable medium having instructions stored therein, which when executed by a processor cause the processor to perform a method including: fetching data from one or more submission queues of a host device; receiving first feedback information from one or more internal queues; controlling transfer of the data from the one or more submission queues to the one or more internal queues based on the first feedback information; receiving second feedback information from a memory device coupled to the processor; and controlling the transfer of the data from the one or more internal queues to the memory device based on the second feedback information.

What is claimed is:

1. A device comprising:
one or more internal queues; and
processing circuitry configured to:
fetch data from one or more submission queues of a host device,
receive first feedback information from the one or more internal queues,
control transfer of the data from the one or more submission queues to the one or more internal queues based on the first feedback information,
receive second feedback information from a memory device coupled to the processing circuitry, and
control the transfer of the data from the one or more internal queues to the memory device based on the second feedback information.

2. The device according to claim 1, wherein the first feedback information includes credit information that controls the transfer of data from the one or more submission queues to the one or more internal queues.

3. The device according to claim 2,
wherein the credit information comprises information indicating an amount of resources used by the data transferred from the one or more submission queues to the one or more internal queues, and
wherein the processing circuitry is further configured to adjust a rate at which data is fetched from the one or more submission queues based on the first feedback information.

4. The device according to claim 1, wherein the first feedback information indicates a rate change for changing a transfer rate at which data is transferred from the one or more submission queues to the one or more internal queues.

5. The device according to claim 4, wherein the rate change increases the transfer rate of the data from the one or more submission queues to the one or more internal queues.

6. The device according to claim 4, wherein the rate change decreases the transfer rate of the data from the one or more submission queues to the one or more internal queues.

7. The device according to claim 1, wherein the processing circuitry is further configured to implement a deficit weight round robin scheduling algorithm for the transfer of the data to and from the one or more internal command queues based on the second feedback information.

8. The device according to claim 7, wherein the processing circuitry, based on the deficit weight round robin algorithm, is further configured to control the transfer of data from the one or more internal command queues based on performance monitoring information after completion of a command.

9. The device according to claim 8, wherein the processing circuitry is further configured to delay an update of a head pointer associated with at least one queue from the one or more submission queues based on the first feedback information.

10. The device according to claim 1,
wherein the second feedback information comprises information indicating an amount of resources used by the data transferred from the one or more internal queues to the memory device.

11. The device according to claim 10, wherein the second feedback information comprises information indicating an amount of memory bandwidth used by the data transferred from the one or more internal queues to the memory device and an amount.

12. The device according to claim 1, wherein the data comprises one or more commands.

13. A method performed by at least one processor, the method comprising:
fetching data from one or more submission queues of a host device;
receiving first feedback information from one or more internal queues;
controlling transfer of the data from the one or more submission queues to the one or more internal queues based on the first feedback information,
receiving second feedback information from a memory device coupled to the processor, and
controlling the transfer of the data from the one or more internal queues to the memory device based on the second feedback information.

14. The method according to claim 13, wherein the first feedback information includes credit information that controls the transfer of data from the one or more submission queues to the one or more internal queues.

15. The method according to claim 14,
wherein the credit information comprises information indicating an amount of resources used by the data transferred from the one or more submission queues to the one or more internal queues, and
wherein the method further comprises adjusting a rate at which data is fetched from the one or more submission queues based on the first feedback information.

16. The method according to claim 13, wherein the first feedback information indicates a rate change for changing a transfer rate at which data is transferred from the one or more submission queues to the one or more internal queues.

17. The method according to claim 16, wherein the rate change increases the transfer rate of the data from the one or more submission queues to the one or more internal queues.

18. The method according to claim 16, wherein the rate change decreases the transfer rate of the data from the one or more submission queues to the one or more internal queues.

19. The method according to claim 13, wherein controlling the transfer of the data from the one or more internal queues to the memory device is further based on a deficit weight round robin scheduling algorithm that controls the transfer of the data to and from the one or more internal command queues to the memory device based on the second feedback information.

20. A non-transitory computer readable medium having instructions stored therein, which when executed by a processor cause the processor to perform a method comprising:
fetching data from one or more submission queues of a host device;
receiving first feedback information from one or more internal queues;
controlling transfer of the data from the one or more submission queues to the one or more internal queues based on the first feedback information;
receiving second feedback information from a memory device coupled to the processor; and
controlling the transfer of the data from the one or more internal queues to the memory device based on the second feedback information.
